(19) United States
(12) Patent Application Publication
(10) Pub. No.: US 2008/0120806 A1
(43) Pub. Date: May 29, 2008

(54) SLIDING HINGE

(75) Inventor: Te-Yang LIU, Shulin City (TW)

Correspondence Address: PATENTTM.US, P. O. BOX 82788, PORTLAND, OR, 97282-0788, US

(73) Assignee: SHIN ZU SHING CO., LTD., Shulin City (TW)

(21) Appl. No.: 11/530,346

(22) Filed: Sep. 8, 2006

(51) Int. Cl. E05D 15/06; E05F 1/16

(52) U.S. Cl. 16/277; 16/362; 248/205.1

(57) ABSTRACT

A sliding hinge has an upper casing, a lower casing and a spring. The upper casing is attached to a cover of an electronic appliance. The lower casing is mounted slidably on the upper casing and is attached to a base of the electronic appliance. The spring is flat in cross section and is mounted between and connects pivotally to the upper and lower casings. Because the spring is flat in cross section, the strength of the spring can be increased without increasing the thickness of the spring. Therefore only use one single spring is strong enough to hold the cover and the base of the electronic appliance.

### BACKGROUND OF THE INVENTION

1. Field of the Invention

The present invention relates to a sliding hinge, especially to a sliding hinge that is mounted between a cover and a base of an electronic appliance to slide the cover relative to the base.

2. Description of the Prior Arts

Portable electronic appliances such as cell phones, personal digital assistants (PDA), etc. have a panel formed on a cover and a base. As modern technology has progressed, portable electronic appliances have become lighter, thinner, shorter and smaller. Thus the cover overlaps the base when the portable electronic appliance is not being used to decrease the volume of the electronic appliance. When the portable electronic appliance is used, the cover is opened relative to the base by a folding hinge or a sliding hinge. The folding hinge allows the cover to pivot relative to the base. The sliding hinge allows the cover to slide relative to the base.

With reference to FIGS. 8 and 9, a conventional sliding hinge comprises an upper casing (60), a lower casing (70) and two springs (80, 90). The upper casing (60) is mounted securely in the cover of the portable electronic appliance. The lower casing (70) is mounted securely in the base of the portable electronic appliance. Each spring (80, 90) has two ends attached pivotally respectively to the upper and lower casing (60, 70). To slide the cover relative to the base, a user exerts force against the elasticity of the springs (80, 90). When the user releases the cover, the elasticity of the springs (80, 90) forces the cover to be fully opened or to be fully closed relative to the base.

To decrease the volume of the portable electronic appliance, the springs (80, 90) must be made of extremely thin material. However, the thin springs (80, 90) are easily deformed or cracked after the thin springs (80, 90) have been used for a while. The deformed or cracked springs (80, 90) cannot provide enough elasticity to hold the cover opened or closed relative to the base.

To overcome the shortcomings, the present invention provides an improved sliding hinge to mitigate or obviate the aforementioned problems.

### SUMMARY OF THE INVENTION

The main objective of the present invention is to provide a sliding hinge with a flat spring. The sliding hinge has an upper casing, a lower casing and a spring. The upper casing is attached to a cover of an electronic appliance. The lower casing is mounted slidably on the upper casing and is attached to a base of the electronic appliance. The spring is flat in cross section and is mounted between and connects pivotally to the upper and lower casings. Because the spring is flat in cross section, the strength of the spring can be increased without increasing the thickness of the spring. Therefore only use one single spring is strong enough to hold the cover and the base of the electronic appliance.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a cell phone with a sliding hinge in accordance with the present invention;

FIG. 2 is an exploded perspective view of another embodiment of the sliding hinge in accordance with the present invention;

FIG. 3 is a perspective view of a flat spring of the sliding hinge in FIG. 1;

FIG. 4 is an operational top view of the sliding hinge in FIG. 1 when the cell phone is opened;

FIG. 5 is an operational top view of the sliding hinge in FIG. 1 when the cell phone is closed;

FIG. 6 is an operational perspective view of the cell phone in FIG. 1 when the cell phone is closed;

FIG. 7 is an operational perspective view of the cell phone in FIG. 1 when the cell phone is opened;

FIG. 8 is an operational top view of a conventional sliding hinge in accordance with the prior art when the cell phone is opened; and

FIG. 9 is an operational top view of the conventional sliding hinge in FIG. 8 when the cell phone is closed.

### DETAILED DESCRIPTION OF THE PREFERRED EMBODIMENTS

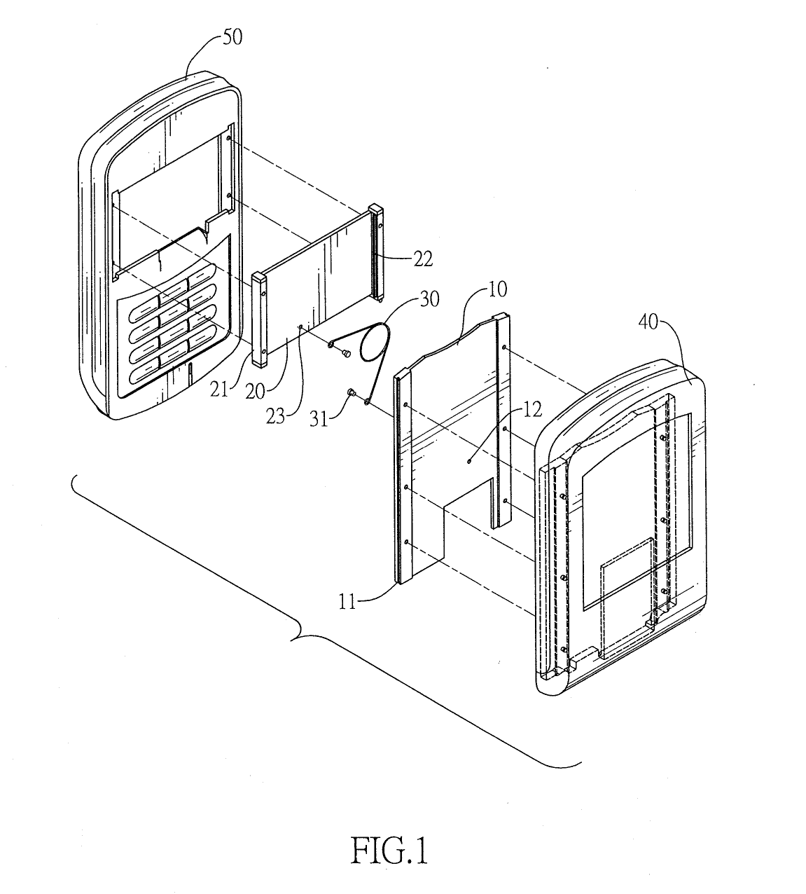

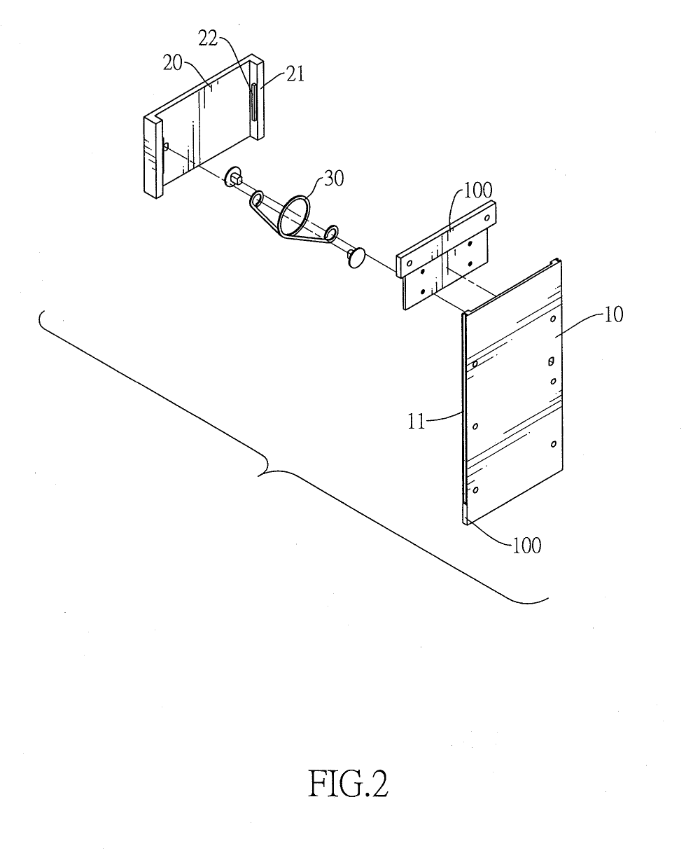

With reference to FIGS. 1 and 2, a sliding hinge in accordance with the present invention comprises an upper casing (10), two stop brackets (100), a lower casing (20), a spring (30) and two fasteners (31).

The upper casing (10) has a front surface, a rear surface, two sides, two ends, two slots (11) and a fastening hole (12). The slots (11) are formed respectively in the two sides of the upper casing (10). Each slot (11) has two ends. The fastening hole (12) is formed through the upper casing (10).

The stop brackets (100) are formed respectively on or are mounted respectively in the two ends of the upper casing (10) and respectively seal two ends of each slot (11) in the upper casing (10).

The lower casing (20) is mounted slidably on the rear surface of the upper casing (10) and has a rear surface, a front surface, two sides, two braces (21), two ribs (22) and a fastening hole (23). The braces (21) are formed respectively on the two sides of the lower casing (20) and respectively correspond to the slots (11) in the upper casing (10). The ribs (22) are formed respectively on the braces (21) and are respectively mounted slidably in the slots (11) of the upper casing (10) to mount the lower casing (20) slidably on the upper casing (10). The ribs (22) selectively abut the stop brackets (100) to keep the ribs (22) from sliding out of the slots (11). The fastening hole (23) is formed through the lower casing (20).

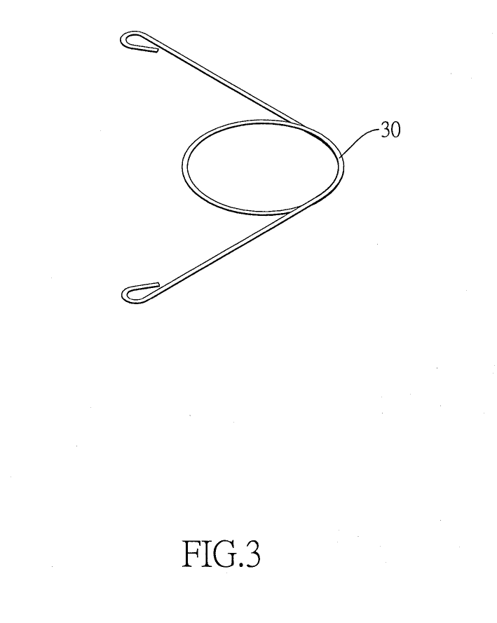

With further reference to FIG. 3, the spring (30) is flat in cross section, is mounted between, connects pivotally to the upper and lower casings (10, 20) and has a first end and a second end. The first end of the spring (30) is mounted pivotally on the rear surface of the upper casing (10). The second end of the spring (30) is mounted pivotally on the front surface of the lower casing (20).

The fasteners (31) respectively extend through the first and second ends of the spring (30) and are respectively mounted securely in the fastening holes (12, 23) of the upper and lower casings (10, 20) to connect the spring (30) pivotally to the upper and lower casings (10, 20).

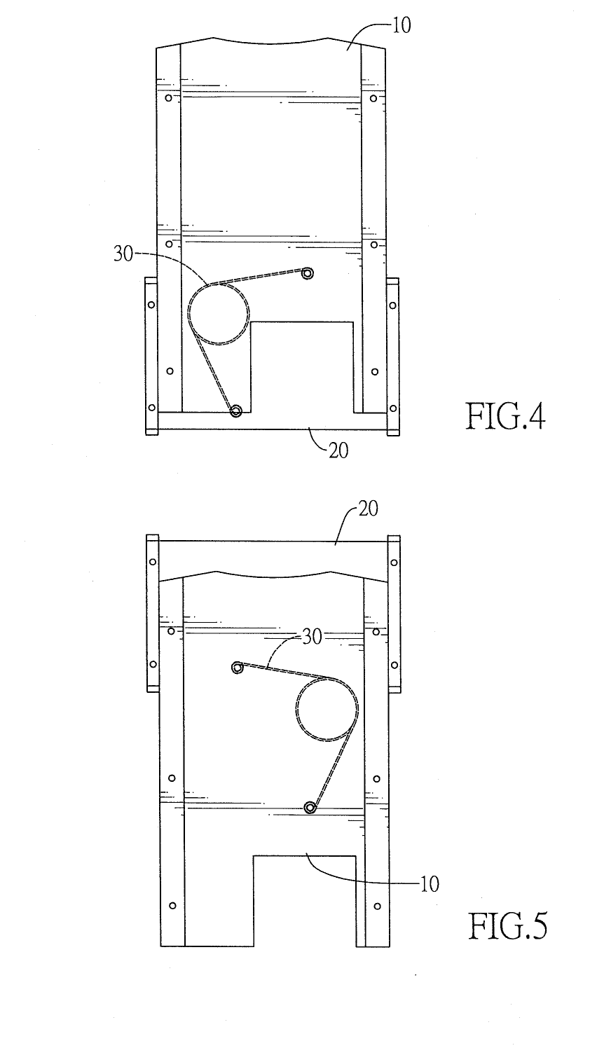

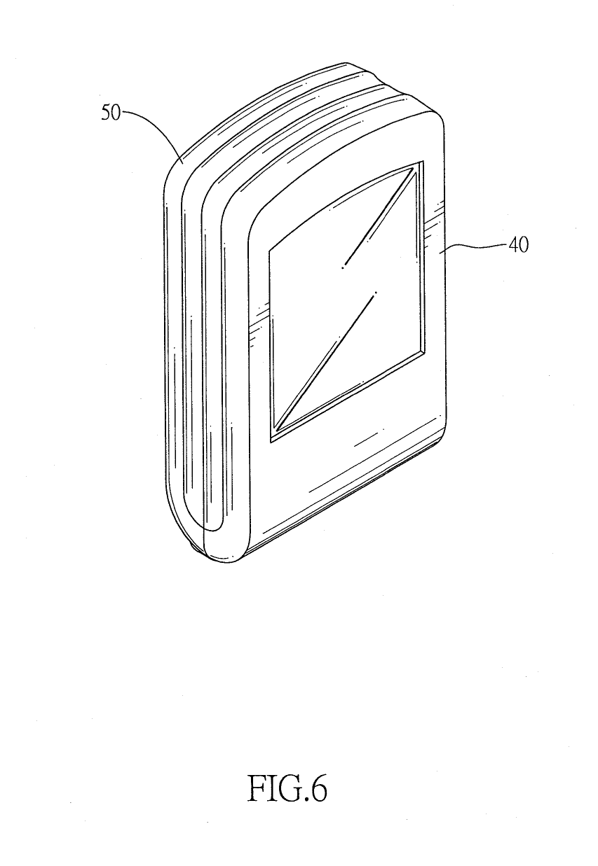

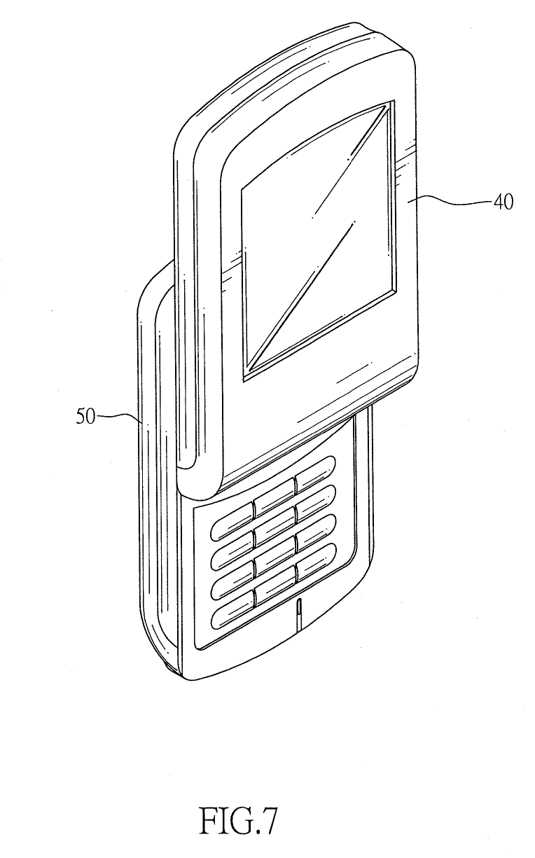

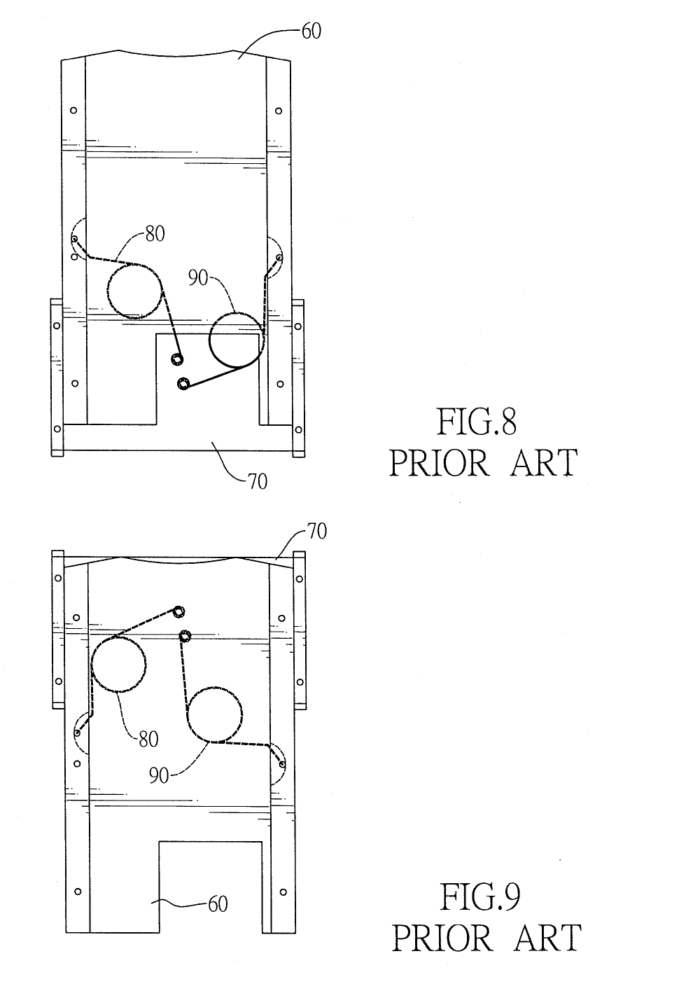

With further reference to FIGS. 4 to 7, a cell phone comprises a cover (40) and a base (50). The front surface of the upper casing (10) is attached to the cover (40). The rear surface of the lower casing (20) is attached to the base (50). To slide the cover (40) relative to the base (50), a user exerts force against the elasticity of the spring (30). When the cover (40) is slightly moved relative to the base (50) and the user releases the force applied to the cover (40), the elasticity of the spring (30) forces the cover (40) to an original position. When the cover (40) is moved relative to the base (50) with a large travel, the cover (40) will be fully opened or closed relative to the base (50) with the elasticity of the spring (30).

The present invention as described has numerous advantages. Increasing the measure of the cross section of the spring (30) can enhance the strength of the spring (30). Because the spring (30) is flat in cross section, the measure of the cross section of the spring (30) can be increased without increasing the thickness of the spring (30). Therefore, the strength of the spring (30) can be enhanced without increasing the thickness of the spring (30). Thus increasing the strength of the spring (30) will not increase the thickness of the cell phone. The cell phone can still be thin and also have the spring (30) strong enough to hold the cover (40) and the base (50). Furthermore, the sliding hinge only needs one single spring (30) because the strength of one single spring (30) can be increased enough to hold the cover (40) and the base (50) without increasing the thickness of the cell phone. Using one spring (30) decreases the manufacturing cost.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A sliding hinge comprising:
an upper casing;
a lower casing mounted slidably on the upper casing; and
a spring being flat in cross section and mounted between and connecting pivotally to the upper and lower casings.

2. The sliding hinge as claimed in claim 1, wherein
the upper casing has
two sides; and
two slots formed respectively in the two sides of the upper casing; and
the lower casing has
two sides;
two braces formed respectively on the two sides of the lower casing and respectively corresponding to the slots in the upper casing; and
two ribs formed respectively on the braces and respectively mounted slidably in the slots of the upper casing.

3. The sliding hinge as claimed in claim 2 further comprising two stop brackets, wherein
the upper casing has two ends;
each slot of the upper casing has two ends;
the stop brackets are formed respectively on the two ends of the upper casing and respectively seal two ends of each slot in the upper casing; and
the ribs of the lower casing selectively abut the stop brackets.

4. The sliding hinge as claimed in claim 2 further comprising two stop brackets, wherein
the upper casing has two ends;
each slot of the upper casing has two ends;
the stop brackets are mounted respectively in the two ends of the upper casing and respectively seal two ends of each slot in the upper casing; and
the ribs of the lower casing selectively abut the stop brackets.

5. The sliding hinge as claimed in claim 1, wherein
the upper casing has a front surface and a rear surface;
the lower casing is mounted slidably on the rear surface of the upper casing and has a front surface and a rear surface; and
the spring has
a first end mounted pivotally on the rear surface of the upper casing; and
a second end mounted pivotally on the front surface of the lower casing.

6. The sliding hinge as claimed in claim 5 further comprising two fasteners, wherein
the upper casing has a fastening hole formed through the upper casing;
the lower casing has a fastening hole formed through the lower casing; and
the fasteners respectively extend through the first and second ends of the spring and are respectively mounted securely in the fastening holes of the upper and lower casings.
